(19) United States
(12) Patent Application Publication
(10) Pub. No.: US 2026/0354468 A1
(43) Pub. Date: Nov. 12, 2026

(54) HEATER FOR AN AEROSOL PROVISION DEVICE

(71) Applicant: Nicoventures Trading Limited, London (GB)

(72) Inventors: Mark POTTER, London (GB); Juan Esteban Paz JAUREGUI, London (GB)

(21) Appl. No.: 19/125,708

(22) PCT Filed: Oct. 24, 2023
(86) PCT No.: PCT/EP2023/079680

§ 371 Date: Apr. 29, 2025

(30) Foreign Application Priority Data
Oct. 31, 2022 (GB) 2216124.4

(51) Int. Cl. A24F 40/46; A24F 40/70; H05B 3/48; H05B 6/10

(52) U.S. Cl. CPC A24F 40/46; A24F 40/70; H05B 3/48; H05B 6/10

(57) ABSTRACT

A heater for an aerosol provision device configured to heat an article containing aerosol generating material is provided. The heater comprises an elongate housing and a heating element in the elongate housing. The elongate housing comprises an overmoulded portion overmoulded over the heating element.

### CROSS-REFERENCE TO RELATED APPLICATIONS

This present application is a National Phase entry of PCT Application No.

PCT/EP2023/079680, filed Oct. 24, 2023, which claims priority from GB 2216124.4, filed Oct. 31, 2022, each of which are fully incorporated herein by reference in their entireties.

### TECHNICAL FIELD

The present invention relates to a heater for an aerosol provision device, an aerosol provision device, an aerosol provision system and a method of forming a heater for an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately induction heating systems are known to be used as heaters.

### SUMMARY

According to an aspect there is provided a heater for an aerosol provision device configured to heat an article containing aerosol generating material, in which the heater comprises an elongate housing, and a heating element in the elongate housing and wherein the elongate housing comprises an overmoulded portion overmoulded over the heating element.

The overmoulded portion may be overmoulded onto the heating element.

The elongate housing may comprise a base and the overmoulded portion may extend from the base towards a free end of the heater.

The elongate housing may comprise a tip and the overmoulded portion may extend from the top towards a base end of the heater.

The elongate housing may define a longitudinal axis and the overmoulded portion may define the longitudinal extent of the elongate housing.

The overmoulded portion may extend between at least two portions of the heating element.

The heating element may comprise a coil. The coil may be a resistive coil. The coil may be a helical coil.

The heating element may comprise a base end electrical path and a return end electrical path. The overmoulded portion may be overmoulded over at least a portion of the return end electrical path.

The overmoulded portion may extend between at least two turns of the coil.

The heating element may at least partially define a void and the overmoulded portion may extend in the void. The heating element may define a void. The overmoulded portion may fill the void.

The overmoulded portion may be electrically insulative.

The heating element may comprise an electrical insulator cover, and the overmoulded portion may be overmoulded onto the electrical insulator cover.

The overmoulded portion may be electrically conductive.

The overmoulded portion may be thermally conductive and configured to conduct heat from the heating element to an overmoulded portion outer surface.

The overmoulded portion may be formed of an overmoulded composition. The overmoulded portion may comprise Polyethylene nanofibers. The overmoulded portion may comprise a matrix and a particulate material. The particulate material may have a thermal capacitance lower than the thermal capacitance of the matrix. The matrix may be a resin. The matrix may comprise one or more of a Polyether ether ketone (PEEK), Polytetrafluoroethylene (PTFE), Polyamide, and Liquid crystal polymer (LCP). The particulate material may comprise at least one of glass and a ceramic. The ceramic may include aluminium nitride.

The particulate material may not be electrically conductive.

The particulate material may comprise microspheres. The microspheres may comprise at least one of a glass and a ceramic. The ceramic may include aluminium nitride.

The heater element may comprise at least one length of resistive material, an electrical input and an electrical output.

The overmoulded portion may be configured to support the heating element.

The heater may comprise a support, wherein the heater element is supported on the support, and the overmoulded portion extends over the heater element and the support. The support may comprise a longitudinally extending shaft extending in the longitudinal direction of the elongate housing. The support may define a support void, the support void being free from the overmoulded portion. The support may be tubular.

The overmoulded portion may be overmoulded over at least a portion of the support.

The overmoulded portion may be overmoulded onto at least a portion of the support.

The support may comprise a base end and a free end, the free end being configured to be easily insertable into an aerosol generating article.

The support may comprise a shaft.

The support may comprise a first portion and a second portion, each portion having a diameter different from the other, wherein the housing abuts only one of the first or second portions.

The support may comprise a step change in diameter. The overmoulded portion may abut the first portion at the base end of the support member. The overmoulded portion may abut the step change.

The overmoulded portion may define at least a portion of a housing outer surface.

The housing may comprise a housing outer surface, at least part of the outer surface comprising a coating having a coefficient of friction lower than that of the coefficient of friction of the outer surface of the housing.

The housing may have a smooth outer surface.

At least 50%, at least 70%, or at least 80% of the area of the outer surface of the housing may support the coating having a coefficient of friction lower than that of the coefficient of friction of the outer surface of the housing.

The heater may be a resistive heating heater.

The heating member may be a resistive heating member.

The heating element may be a resistive heating element.

The coil may be a resistive heating heater coil

The heater may be an inductive heating heater.

The heating element may be an inductive heating element.

The coil may be an inductive coil.

According to another aspect there is provided a heater for an aerosol provision device configured to heat an article containing aerosol generating material, in which the heater comprises an elongate housing and a heating element in the elongate housing, wherein the elongate housing comprises a sintered portion and at least a portion of the heating element is embedded within the sintered portion.

The sintered portion may be sintered after the heating element is embedded in the sintered portion.

The heater may be a resistive heating heater. The heating member may be a resistive heating member. The heating element may be a resistive heating element. The coil may be a resistive heating heater coil. The heater may be an inductive heating heater. The heating element may be an inductive heating element. The coil may be an inductive coil.

According to another aspect there is provided a heater for an aerosol provision device configured to heat an article containing aerosol generating material, in which the heater comprises an elongate housing and a heating element in the elongate housing, wherein the elongate housing comprises a formed portion and at least a portion of the heating element is embedded within the formed portion. In embodiments, the formed portion is a sintered portion.

In embodiments, the formed portion is an overmoulded portion.

According to an aspect there is provided an aerosol provision device configured to heat an article containing aerosol generating material, the device comprising a heater described in any of the above.

According to an aspect there is provided an aerosol provision device configured to heat an article including aerosol generating material, comprising a receptacle configured to receive at least a portion of an article including aerosol generating material, a heater protruding in the receptacle comprising a housing and a heating element in the housing, wherein the housing comprises a sintered portion provided over at least a portion of the heating element protruding in the receptacle.

According to an aspect there is provided an aerosol provision device configured to heat an article including aerosol generating material, comprising a receptacle configured to receive at least a portion of an article including aerosol generating material, a heater protruding in the receptacle comprising a housing and a heating element in the housing, wherein the housing comprises an overmoulded portion overmoulded over at least a portion of the heating element protruding in the receptacle.

At least a portion of the overmoulded portion may protrude in the receptacle.

The receptacle may define a heating chamber.

The overmoulded portion may fluidly isolate the heating element from the heating chamber.

According to an aspect there is provided a system comprising any of the heater or the aerosol provision device described above, and an article comprising aerosol generating material.

According to an aspect there is provided a method of forming a heater for an aerosol provision device configured to heat an article containing aerosol generating material, the method comprising providing an elongate heating element, overmoulding a mould material over at least a portion of the heating element to form an elongate housing.

According to an aspect there is provided a method of forming a heater for an aerosol provision device configured to heat an article containing aerosol generating material, the method comprising providing an elongate heating element, and sintering a sintering material over at least a portion of the heating element to form an elongate housing.

According to an aspect, there is provided an aerosol provision device configured to heat an article comprising aerosol generating material, the device comprising a heater described in any of the above. The aerosol provision device may comprise a heating chamber, in which the heater is provided.

The aerosol provision device may comprise a power source, a controller and a heating chamber, in which the aerosol generating article is removeable received. The power source may be aligned along a longitudinal axis of the heating chamber. The power source may be aligned along a second longitudinal axis, parallel to the longitudinal axis of the heating chamber.

The aerosol provision device may be configured for wireless charging.

According to an aspect there is provided an aerosol provision system comprising: an aerosol provision device as described above; and an article comprising aerosol generating material.

The aerosol provision system may comprise a charging unit having a cavity for removably receiving the aerosol provision device. The charging unit may comprise a moveable lid, which covers the aerosol provision device in a closed configuration. The charging unit may comprise a user display. The user display may be visible to a user when the moveable lid is in a closed position and is partially or fully concealed or obscured from sight by the lid when the lid is an open position.

According to another aspect there is provided a method of generating aerosol comprising: providing an aerosol provision device comprising a heater as described above, at least partially inserting an aerosol generating article into the receiving portion of the heating chamber.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of a heater of the device of FIG. 1 or FIG. 4; and

FIG. 7 shows a schematic cross-sectional view of another heater of FIG. 1 or FIG. 4.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

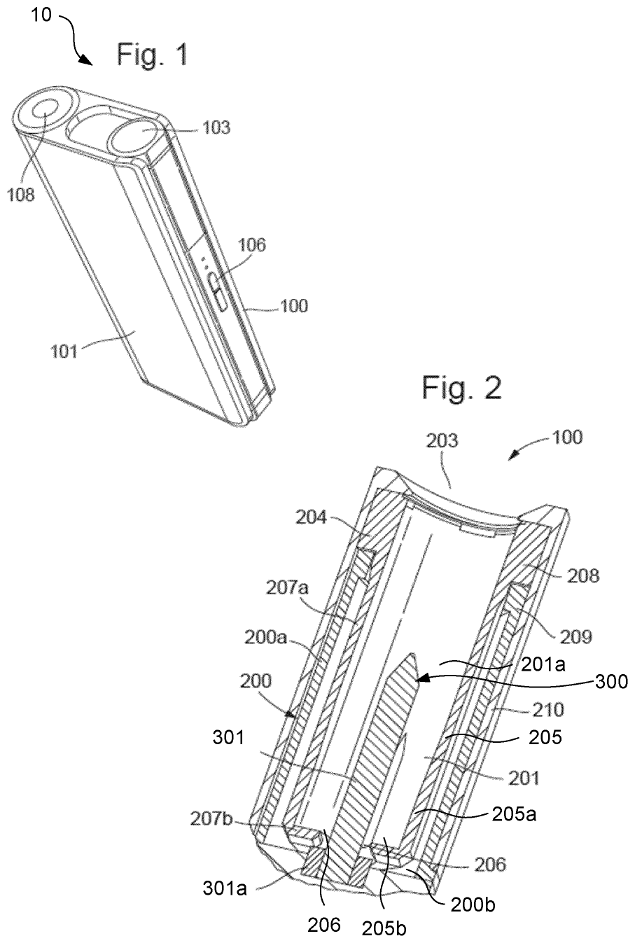

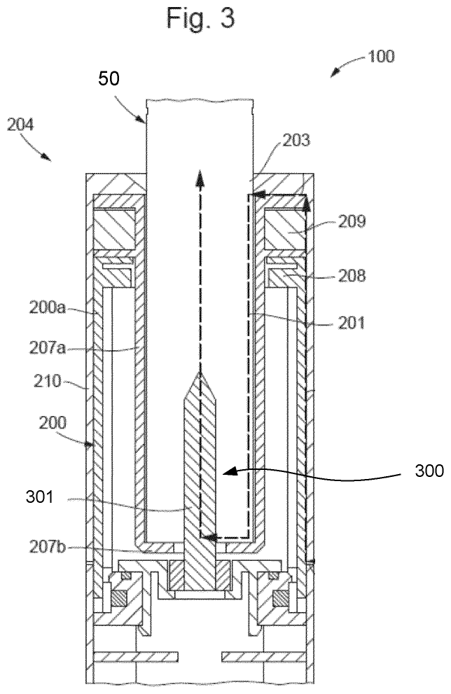

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross-sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured at least a portion of the article for heating.

A heating member 301 is provided in a portion of the main housing 200 and the heating member 301 extends or projects into the heating chamber 201. The heating member 301 acts as a heater. The heating member 301 may comprise a base portion 301a which may be located in a recess provided in a portion of the body of the device 100. The heating member 301 upstands in the heating chamber 201. The heating member 301 upstands from the distal end.

The heating member 301 comprises an elongate heating member in the form of a pin. The heating member 301 in other embodiments comprises other elongate configurations, such as a blade. The heating member 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heating member 301 upstands from the housing base 200b. The heating member 301 protrudes through the receptacle base 205b. An aperture 206 is formed in the receptacle base 205b through which the heating member 301 protrudes. In embodiments, the heating member 301 is mounted to the receptacle base 205b. The heating member 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heating member 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving, the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heating member 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding comprising one feature or two features fixed in a moulding process). Alternatively, the tubular portion 207a and base portion 207b may comprise a first component and the outer cap portion 210 may comprise a second separate component. The first and second components may then be secured together.

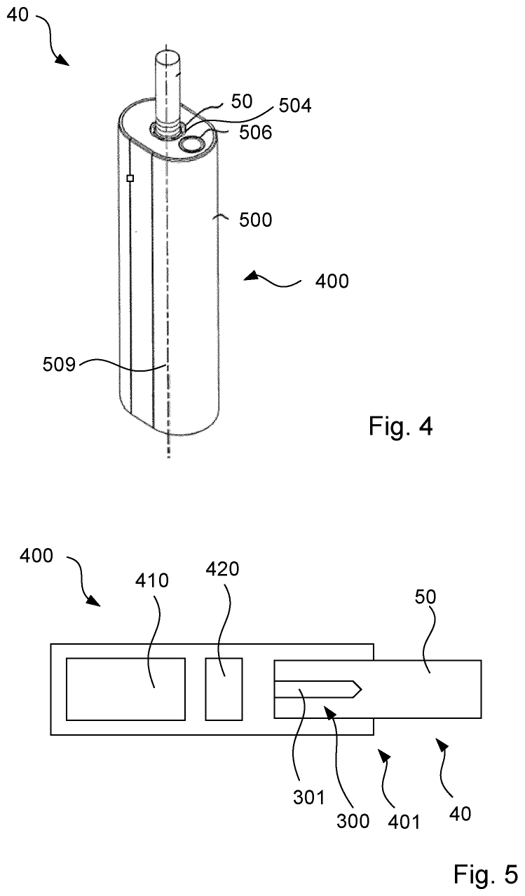

FIG. 4 shows another aerosol generating system 40. The system 40 comprises a one-piece aerosol generating device 400 for generating aerosol from an aerosol generating material, and the aerosol generating article 50 comprising the aerosol generating medium. The device 400 can be used to heat the aerosol generating article 50 comprising the aerosol generating medium, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol generating system 40. Features described with reference to FIG. 5 in embodiments are applicable to embodiments described above. The aerosol generating device comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol generating device, the power source is aligned along a second longitudinal axis, parallel to the longitudinal axis of the heating chamber.

The heating member 301 comprises an elongate heating member in the form of a pin. The heating member 301 in embodiments comprises other elongate configurations, such as a blade. The heating member 301 is provided in the heating chamber. The heating member 301 of FIG. 5 and the heating member 301 described above with reference to FIGS. 1 to 3, such that details described herein may be applied to each. The heating member 301 extends or projects into the heating chamber 401.

The heating member 301 may be inserted, in use, into a distal end of the aerosol generating article which is received within the heating chamber 401 in order to internally heat the aerosol generating article.

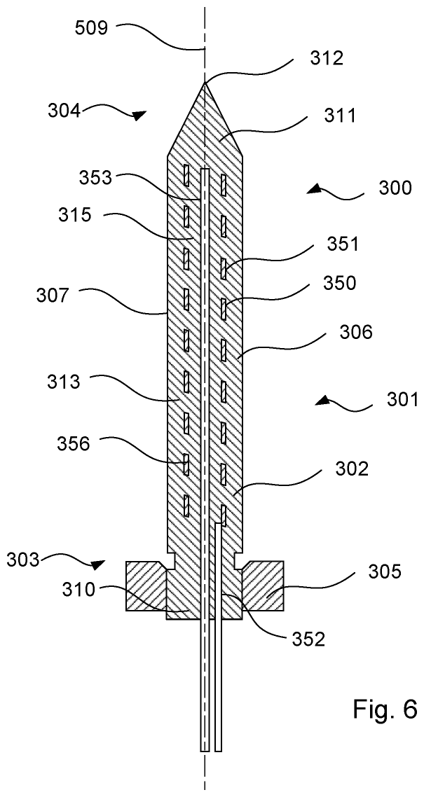

The aerosol provision devices 100, 400 comprise a heating arrangement 300. The heating arrangement 300 comprises a heater. The heating member 301 acts as the heater. The heater comprises a heating element 350 (refer to FIG. 6), such as a resistive heating coil, arranged to be actuated to heat the heating member.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heating member 301 for use in an aerosol provision device as described above. The heating member 301 acts as or forms at least part of a heater. The heating arrangement 300 comprises the heating member 301. The heating member 301 comprises an elongate housing 302 and the heating element 350. The elongate housing 302 is an elongate member defining a longitudinal axis. The housing 302 forms a cover for the heating element 350. The housing 302 and the heating element 350 are integrally formed. The housing 302 and the heating element 350 are inseparable following a manufacturing process of the heating member 301.

The elongate housing 302 comprises a housing body 306. The housing body 306 is tubular. The housing body is cylindrical. Other external shapes are anticipated.

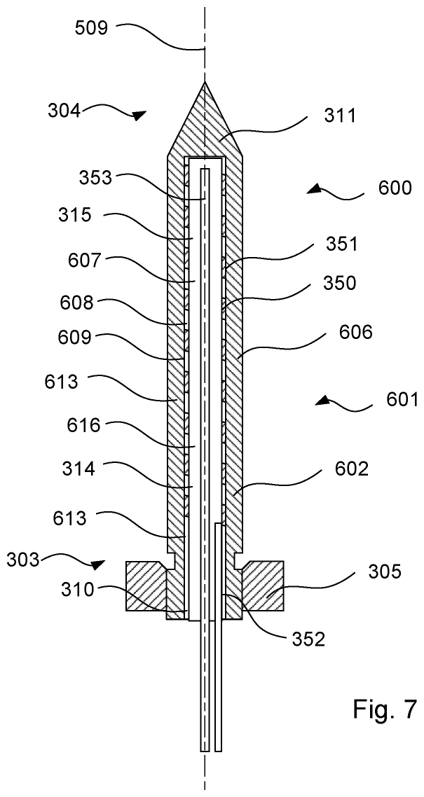

The elongate housing 302 is formed by overmoulding. The elongate housing 302 comprises an overmoulded portion 313. The overmoulded portion 313 acts as a formed portion. In FIGS. 6 and 7, the entire elongate housing 302 is formed by the overmoulded portion 313. In embodiments, at least a portion of the elongate housing comprises the overmoulded portion. In some embodiments as described below the housing comprises the overmoulded portion 313 and a further component, such as part of at least one of a base, a tip and a support.

The overmoulded portion 313 is overmoulded over the heating element 350. In the arrangement shown in FIG. 6 the overmoulded portion 313 is overmoulded onto the heating element 350. The overmoulded portion 313 is in contact with the heating element 350. In embodiments the heating element 350 comprises an electrically insulative layer, such as a ceramic coating. In embodiments, the overmoulded portion 313 is formed from an electrically insulative layer. In such embodiments the electrically insulative layer of the heating coil may be omitted. The overmoulded portion 313 is in contact with at least an external surface of the heating element 350. The housing 302 acts to support the heating element 350.

The overmoulded portion 313 defines at least a portion of an outer surface 307 of the elongate housing 302. The elongate housing may comprise a coating on its outer surface. In embodiments, the overmoulded portion 313 is overmoulded over the heating element 350 such that the heating element does not directly contact the overmoulded portion as described below.

The elongate housing 302 is formed from a thermally conductive material. The elongate housing 302 is configured to transfer heat from the heating element 350 to the heating zone 201a. The overmoulded portion 313 is configured to transfer heat from the heating element to the outer surface 307 of the elongate housing 302. The overmoulded portion 313 is thermally conductive.

The elongate housing 302 has a base end 303 and a free end 304. The base end 304 mounts to the device body. A mount 305 at the base end 303 mounts the heating member 301. The mount in embodiments may be formed from a thermally insulative material. It will be understood that different mounting arrangements may be used, for example at least one of fixing, moulding, and bonding including adhering. The mount 305 may be a separate component or may be integrally formed with the elongate housing 302. The mount may form part of the overmoulded portion.

The free end 304 of the elongate housing 302 extends towards the proximal end of the heating chamber. The free end 304 of the heating member 301 is closed. A tip 311 is provided at the free end 304. The tip 311 extends to an apex 312. The tip 311 defines a conical shape. Other shapes and configurations of the tip 311 may be provided, for example the tip 311 may define a planar surface, a frusto-conical surface, or a domed surface. Forming the tip from the overmoulded portion 313 aids formation of a suitably shaped tip 311.

The heating element 350 extends in the overmoulded portion 313. The heating element 350 extends in the elongate housing 302 in the longitudinal direction. The heating element 350 extends between the base end 303 and the free end 304. In embodiments the heating element 350 extends to or beyond the base end 303.

The overmoulded portion 313 extends around the heating element 350 from the base of the heating member 301 towards the free end 304. The overmoulded portion 313 may extend around the heating element 350 from the top of the heating member 301 towards the base. The heating element 350 is enclosed by the overmoulded portion 313. The overmoulded portion 313 provides improved heating of the article and an improved thermal pathway between the coil and the article. Overmoulding provides a simple method of manufacturing to ensure fluid impermeability through the elongate housing. The overmould helps to prevent any moisture build up in the heating chamber 201, such as condensate, from reaching the heating element 350. The overmoulded portion 313 can provide support to the heating element 350, such that further supporting elements are not required.

The elongate housing 302 defines the housing outer surface 307. In embodiments, at least a part of the outer surface 307 comprising a coating. The coating may have a lower coefficient of friction than the outer surface of the elongate housing 302. This provides for improved insertion of the article and allows the user to clean the heating arrangement 300 including the heating member 301.

The overmoulded portion 313 extends longitudinally along the extent of the elongate housing 302. The overmoulded portion 313 extends along the longitudinal axis 509. The overmoulded portion 313 extends at least 50%, 70% or 90% of the longitudinal length of the elongate housing 302. At least 50%, 70% or 80% of the area of the outer surface of the elongate housing 302 may comprise the material coating.

The heating element 350 comprises a heating coil 351. The heating coil 351 comprises a resistive member defining the heating coil 351. In embodiments the heating coil 351 comprises an electrically insulative coating, such as a ceramic, to electrically insulate the heating coil 351. The electrically insulative coating in embodiments is thermally conductive to provide for heat transfer from the heating element 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heating element 350 to the elongate housing 302. In embodiments, such as shown in FIG. 6, the overmoulded portion 313 acts as an electrically insulative arrangement.

The heating coil 351 is a resistive heating coil. The heating coil 351 is a helical coil. The heating coil 351 has a rectangular cross-sectional profile. It will be understood that other coil configurations are possible. In embodiments, the heating coil 351 has a circular cross-sectional profile. In embodiments, the heating arrangement 300 comprises two or more heating coils.

In FIG. 6, the overmoulded portion 313 is overmoulded such that it extends between portions of the heating coil 351. The heating coil 351 comprises a plurality of turns 356. The overmoulded portion 313 extends between consecutive turns of the heating coil 351. The overmoulded portion 311 may extend entirely between consecutive coil turns of the heating coil 351. In embodiments, the overmoulded portion may at least partially extend between consecutive coil turns. The overmoulded portion 313 fills a central extent of the heating coil 351. The overmoulded portion 313 is solid. The overmoulded portion 313 is free from chambers. This aids an even heat distribution.

The overmoulded portion 313 comprises a thermally conductive material. The overmoulded portion 313 may comprise an electrically insulative material. The overmoulded portion 313 may comprise an electrically conductive material, where the heating element 350 comprises an electrically insulated coating. The overmoulded portion 313 comprises a composition comprising a matrix and a particulate material. In embodiments, the matrix comprises a high temperature plastic. The matrix may be a resin. The matrix may comprise one or more of a Polyether ether ketone (PEEK), Polytetrafluoroethylene (PTFE), Polyamide, and Liquid crystal polymer (LCP). The overmoulded portion may comprise Polyethylene nanofibers. The matrix may be formed of or comprise one or more other suitable materials.

The particulate material may have a lower thermal capacitance than that of the matrix. The particulate material may comprise an electrically insulative material such as glass. The particulate material may comprise microspheres, or more specifically glass or ceramic microspheres. In embodiments, the particulate material comprises at least one of glass and ceramic. The ceramic may, for example, include aluminium nitride. The particulate material may be formed of or comprise one or more other suitable materials. FIG. 7 shows an embodiment of the heating arrangement 600 in which the overmoulded portion 613 is overmoulded such that at least part of the heating member is free from the overmoulded portion 613. Features described with reference to embodiments described below with reference to FIG. 7 are applicable to features described above unless otherwise indicated, and vice versa. In the shown embodiment the overmoulded portion 613 does not extend between portions of the heating coil 351. The overmoulded portion 613 as shown does not extend between the turns of the heating coil 351 such that an inner surface 609 of the overmoulded portion 613 does not extend radially inward of an outer surface of the heating coil 351. In order to achieve this, the heating coil 351 may comprise a cover 614, such as a wrap, to restrict overmoulding material of the overmoulded portion 613 from entering the space between turns of the heating coil 351. In embodiments, the pitch of the turns of the heating coil has a tight pitch are such that overmoulding material of the overmoulded portion is restricted from cannot enter between the turns of the heating coil.

The elongate housing 602 comprises the housing body 606. The housing body 606 is tubular. The housing body 606 comprises a bore 607. The housing body is cylindrical. Other external shapes are anticipated. The bore 607 defines an inner void 608 of the heating member 601. The inner void 608 extends longitudinally. In embodiments, the inner void 608 is at least partially filled, for example with a filler. In embodiments, the inner void 608 is completely filled, for example with one or more fillers and/or components. In embodiments, the inner void 608 defines an air gap. An inner surface 609 is defined on an inner side of the elongate housing 602. An open end 310 to the inner void 608 is provided at the base end 303. The overmoulded portion 613 does not extend radially inwardly of the bore 607.

FIG. 7 also shows a support member 616. The support element extends along the longitudinal axis 509. In the shown embodiment, the support element extends within the heating element 350. In embodiments, the support element is omitted. The support member 616 extends in an axial direction radially within the heating element 350. The support member 616 extends within the inner void 608 of the heating member 601. The heating coil 351 is wound around the support member 616 such that heating coil is disposed between the support member 616 and overmoulded portion 613. The heating coil 351 is disposed on the support member 616. The overmoulded portion 613 is overmoulded over the support member 616 and the heating element 350. The overmoulded portion 613 abuts the support member 616 to retain the heating element.

The support member 616 comprises a longitudinally extending shaft extending in a longitudinal direction along the longitudinal axis 509. The support member 616 is tubular. The support member 616 may have another arrangement such as a solid member, for example a cylinder. The support member 616 may comprise a shaft. In embodiments, the heating element 350 is self-supporting. The support element in embodiments extends from the receptacle. In embodiments, the support element is spaced from the receptacle. In embodiments, the overmoulded portion supports the heating element 350. In embodiments, the overmoulded portion may extend radially within the external surface of the heating coil 351 and contact the support member 616.

The support member 616 has a base end 314 and a free end 315. The support member 616 has two portions, a first portion at the base end 314 and a second portion at the free end 315. In embodiments, the heating element 350 is supported on only one of the first or second portions. In embodiments, the two portions have different external diameters such that the base end 314 has a different diameter to the free end 315. In embodiments, the support member 616 has a step change between the base end 314 and the free end 315. The overmoulded portion 313 may abut the first portion at the base end 314 of the support member 316.

In the described embodiments, the tip and the base are formed from the overmoulded portion. In embodiments, a portion of the free end 304, such as the tip 311, is formed from a preformed element, over which the overmoulded portion is formed. The preformed element and overmoulded portion may therefore form an integral component. The overmoulded portion may extend from the base towards the free end.

In embodiments, a portion of the base end 303, such as the base 305, is formed from a preformed element, over which the overmoulded portion is formed. The preformed element and overmoulded portion may therefore form an integral component. The overmoulded portion may extend from the base towards the free end. In embodiments, both of the tip and the base are pre-formed elements or part of a single pre-formed element. The overmoulded portion may extend between the tip and the base. One or both of the tip and the base may define a shoulder from which the overmoulded portion extends.

In embodiments, the support member 316 defines at least one of the tip and the base. In embodiments, the overmoulded portion supports at least one of the preformed tip and base.

In embodiments, the elongate housing is sintered over the heating element. The elongate housing may comprise a sintered portion. The sintered portion acts as a formed portion. The arrangement of the sintered configuration described herein generally corresponds to the arrangement of the overmoulded configuration as described above, and features and description provided above with respect to the overmoulded configuration are applicable to the sintered configuration described herein. A further detailed discussion is therefore omitted. Reference may be made to the Figures used above in describing the overmoulded portion.

The heating element is embedded in the sintered portion of the elongate housing. At least a portion of the heating element is embedded in embodiments. The heating element is positioned in a suitable sintering material, such as a ceramic. The ceramic sintering material in embodiments includes aluminium nitride, although other suitable sintering materials may be used. The sintering material is sintered to form the sintered portion. The heating element is embedded within the sintered portion. The sintered portion encapsulates the heating element. The sintering material may comprise a powder which, on application of heat or pressure, becomes a solid sintered portion. The sintering material is compacted and formed into a solid without melting the material to the point of liquefaction. The sintering material may comprise at least one of a glass, ceramic or plastic. The sintered portion may be sintered over the heating element while the heating element is within the sintering material.

The heating arrangement 300, 600 comprises electrical connection paths. The electrical connection paths extend from each end of the heating element 350. A base electrical connection path 352 extends from the distal end of the heating element 350. A return electrical connection path 353 extends from the proximal end of the heating element 350. The return electrical connection path overlaps the longitudinal extent of the heating element 350. The electrical connection paths are integrally formed with the heating element, for example as a single wire. In embodiments, connectors connect the electrical connection paths with the heating element 350. The heating coil 351 is formed from a resistive material, such as a nickel/chrome alloy such as nichrome 80/20 (80% Nickel, 20% Chromium), an iron/chrome/aluminium alloy, or a copper/nickel alloy.

In the above-described embodiments, the heating arrangement is a resistive heating arrangement. In embodiments, other types of heating arrangement are used, such as inductive heating. In such embodiments, a low or non-resistive material may be used. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device configured to heat an article containing aerosol generating material, in which the heater comprises:
an elongate housing; and
a heating element in the elongate housing;
wherein the elongate housing comprises an overmoulded portion overmoulded over the heating element.

2. The heater of claim 1, wherein the overmoulded portion is overmoulded onto the heating element.

3. The heater of claim 1, wherein the elongate housing comprises a base and the overmoulded portion extends from the base towards a free end of the heater.

4. The heater of any of claim 1, wherein the elongate housing comprises a tip and the overmoulded portion extends from the tip towards a base end of the heater.

5. The heater of claim 1, wherein the elongate housing defines a longitudinal axis and the overmoulded portion defines the longitudinal extent of the elongate housing.

6. The heater of any of claim 1, wherein the overmoulded portion extends between at least two portions of the heating element.

7. The heater of any of claim 1, wherein the heating element comprises a coil.

8. The heater of any of claim 1, wherein the coil is a resistive heating coil.

9. (canceled)

10. The heater of any of claim 1, wherein the heating element at least partially defines a void, and wherein the overmoulded portion extends in the void.

11. The heater of any of claim 1, wherein the overmoulded portion is electrically insulative.

12. The heater of any of claim 1, wherein the overmoulded portion is thermally conductive and configured to conduct heat from the heating element to an overmoulded portion outer surface.

13. The heater of any of claim 1, wherein the overmoulded portion is formed of an overmoulded composition comprising a matrix and a particulate material.

14. The heater of any of claim 1, wherein the overmoulded portion is configured to support the heating element.

15. The heater of any of claim 1, comprising a support, wherein the heater element is supported on a support, and the overmoulded portion extends over the heater element and the support.

16. The heater of any of claim 1, wherein the overmoulded portion defines at least a portion of a housing outer surface.

17. The heater of any of claim 1, wherein the heater is a resistive heating heater.

18. A heater for an aerosol provision device configured to heat an article containing aerosol generating material, in which the heater comprises:
an elongate housing; and
a heating element in the elongate housing;
wherein the elongate housing comprises a sintered portion and at least a portion of the heating element is at embedded within the sintered portion.

19. An aerosol provision device configured to heat an article including aerosol generating material, comprising:
a receptacle configured to receive at least a portion of an article including aerosol generating material;
the heater of claim 1, protruding in the receptacle,
wherein the overmoulded portion is over at least a portion of the heating element protruding in the receptacle.

20. A system comprising the heater according to claim 1 and an article comprising aerosol generating material.

21. A method of forming the heater of claim 1 for an aerosol provision device configured to heat an article containing aerosol generating material, the method comprising:
providing an elongate heating element;
overmoulding an overmould material over at least a portion of the heating element to form an elongate housing.
